(19) United States
(12) Patent Application Publication
(10) Pub. No.: US 2021/0198514 A1
(43) Pub. Date: Jul. 1, 2021

(54) SOUND REDUCING COATING COMPOSITION

(71) Applicant: SoundGuard Products, LLC, Raleigh, NC (US)

(72) Inventors: David Fine, West Hartford, CT (US); Audrey Emanuel, West Hartford, CT (US)

(21) Appl. No.: 16/650,478

(22) PCT Filed: Jan. 23, 2018
(86) PCT No.: PCT/US2018/014771

§ 371 Date: Mar. 25, 2020

Related U.S. Application Data
(60) Provisional application No. 62/564,421, filed on Sep. 28, 2017.

(51) Int. Cl. C09D 131/04; C09D 133/12; C08K 3/32; C08K 3/38; C09D 7/20; C09D 7/61; C08L 75/08; C08K 3/30

(52) U.S. Cl. CPC C09D 131/04; C09D 133/12; C08K 3/32; C08K 3/38; C08K 2003/3045; C09D 7/61; C08K 2003/327; C08K 2003/325; C08L 75/08; C09D 7/20

(57) ABSTRACT

Provided herein are architectural coating compositions having sound-reducing properties. The coating compositions comprise a high-density pigment component. Preferably, the high-density pigment component has a density of at least about 3 grams/cm³. In one embodiment, the high-density pigment component comprises barium sulfate.

### CROSS-REFERENCE TO RELATED APPLICATIONS

This application claims the benefit of U.S. Provisional Application No. 62/564,421, filed Sep. 28, 2017, which is hereby incorporated by reference in its entirety.

### BACKGROUND

In many buildings and structures, such as hotels, apartment buildings, and office buildings, it is desirable to prevent the transmission of sound waves between neighboring rooms. Unfortunately, existing soundproofing technologies are often expensive, ineffective, or difficult to install.

There is therefore a need in the market for a soundproofing product that can significantly reduce and/or eliminate sound transmission through walls and ceilings, is cost-effective, and can be incorporated into existing buildings without the need for extensive construction or remodeling.

### SUMMARY

In one aspect, provided herein is a coating composition that is useful as a sound-reducing architectural coating. The coating composition comprises a high-density pigment component in a concentration of at least about 10% by weight, wherein the high-density pigment component has a density of at least about 3 grams/cm³.

Also provided is a method of preparing a coating composition as described herein.

Also provided herein is a method of reducing the transmission of sound into an interior room, the method comprising applying an architectural coating composition as provided herein to an interior wall, floor, or ceiling surface.

Other objects and features will be in part apparent and in part pointed out hereinafter.

### DETAILED DESCRIPTION

Provided herein are compositions that are useful as architectural coatings. The coatings are suitable for application, for example, to interior or exterior wall, floor, and ceiling surfaces.

Advantageously, in some embodiments, the coatings may act to reduce the transmission of sound waves through the surface to which they are applied. This property is particularly useful in buildings and structures, such as hotels, apartment buildings, and office buildings, where it is desirable to reduce the transmission of sound waves between neighboring rooms.

The coating compositions described herein typically have a specific gravity (relative to water) of significantly greater than 1. For example, the coating composition may have a specific gravity greater than about 1.1, greater than about 1.2, greater than about 1.3, greater than about 1.4, or even greater than about 1.5.

The coating compositions described herein are preferably water-based compositions. Water typically comprises from about 10% to about 60% by weight, for example from about 20% to about 50% by weight, from about 25% to about 40% by weight, from about 25% to about 35% by weight, from about 30% to about 40% by weight, or from about 30 to about 36% by weight.

The coating compositions described herein typically have a solids content of at least about 40% by weight, for example at least about 45% by weight, at least about 50% by weight, at least about 55% by weight, or even at least about 60% by weight. The solids content typically ranges from about 40% to about 80% by weight, for example from about 50% to about 75% by weight, from about 55% to about 70% by weight, or from about 60% to about 70% by weight. On a volumetric basis, the coating compositions typically have a solids content of from about 30% to about 60%, for example from about 35% to about 55%, from about 40% to about 55%, from about 30% to about 50%, or from about 40% to about 50%.

The coating compositions described herein typically have a total pigment content—including the color pigment, high density pigment component, pigment extender, and any inhibitor pigments—of at least about 25% by weight, for example at least about 30% by weight, at least about 35% by weight, or even at least about 40% by weight. For example, the pigment content may range from about 20% to about 60% by weight, from about 30% to about 60% by weight, from about 35% to about 55% by weight, or from about 40% to about 50% by weight. On a volumetric basis, the coating compositions described herein typically have a pigment content of from about 10% to about 30%, for example from about 10% to about 25%, from about 10% to about 20%, from about 10% to about 25%, or from about 15% to about 20%.

As described in further detail below, the coating compositions described herein may be prepared using a preferred method in which the components are combined in various stages before formation of the final coating composition. For example, in one embodiment of the preferred preparation method, certain components are first combined with the pigment components to form a grind composition; and the remaining components are combined to form a letdown composition. The grind composition is subsequently combined with the letdown composition, thereby forming the sound reducing coating composition described herein.

It is noted, however, that any coating composition comprising the components described herein—regardless of its method of preparation, or the manner in which those components are combined—falls within the scope of the present disclosure and the attached claims.

### Organic Solvent

The coating composition can comprise an organic solvent component. In preferred embodiments, the organic solvent component comprises a diol. Non-limiting examples of suitable diols include ethylene glycol and propylene glycol. For example, the organic solvent component may comprise propylene glycol.

The coating composition typically comprises an organic solvent component in a concentration of from about 0.5% to about 5% by weight, for example from about 1% to about 4% by weight, or from about 1% to about 3% by weight.

### Defoamer

The coating composition may further comprise a defoamer. Non-limiting examples of defoamers include silicones, oils, and waxes. For example, the defoamer can comprise a silicon-containing polymer. Non-limiting examples of commercially available defoamers include DAPRO DF101 (a blend of emulsifiers, silica and silicone), DAPRO DF10 (a blend of hydrophobic silica, emulsifiers, and oil), DAPRO DF451 (a blend of oil, glycols and modified polysiloxanes), and DAPRO DF 7005 (a silicone-free, ultra-fine dispersion of wax in mineral oil), available from Elementis Specialties; DOW 71 (a silicone-based polymer) and DOW 74 (a silicone-based polymer), available from Dow Corning; BYK 022 (polysiloxanes and hydrophobic solids in polyglycol); and TEGO FOAMEX 810 (a polyether siloxane copolymer with fumed silica).

The coating composition typically comprises a defoamer in a concentration of from about 0.2% to about 1.5% by weight, for example from about 0.2% to about 1% by weight, or from about 0.3% to about 0.8% by weight.

### Dispersant

The coating composition may further comprise a dispersant. The dispersant may comprise, for example, an anionic dispersant, a cationic dispersant, or a nonionic dispersant. In a preferred embodiment, the composition comprises an anionic dispersant. Non-limiting examples of commercially available anionic dispersants include DISPEX AA 4140 (a sodium polyacrylate copolymer), DISPEX AA 4414, and EFKA 3650N (a fluorinated polyacrylate polymer), available from BASF. Additional non-limiting examples of commercially available dispersants include ACUSOL 420N, NUOSPERSE 2006, NUOSPERSE FX35, and DISPARALON AQ 7533.

The coating composition typically comprises a dispersant in a concentration of from about 0.2% to about 1.5% by weight, for example from about 0.2% to about 1% by weight, or from about 0.3% to about 0.8% by weight.

### Co-Dispersant

The coating composition may further comprise a co-dispersant. The co-dispersant may comprise, for example, an anionic dispersant, a cationic dispersant, or a nonionic dispersant. The co-dispersant preferably comprises a cationic dispersant. In a preferred embodiment, the co-dispersant comprises 2-amino-2-methyl-1-propanol. Additional, non-limiting examples of commercially available co-dispersants include FLEXITANE CA 6000, TAMOL 960, TAMOL, 681, TAMOL 981, TEGO 651, TEGO 652 TEGO 660C TEGO 656, and TEGO 660.

The coating composition typically comprises a co-dispersant in a concentration of from about 0.02% to about 0.5% by weight, for example from about 0.05% to about 0.2% by weight.

### Thickening Agent

The coating composition may further comprise a thickening agent. Suitable thickening agents may be derived, for example, from cellulose, clay, or silicate materials. For example, the thickening agent may comprise a cellulose thickener. Non-limiting examples of cellulose thickeners include methyl cellulose, hydroxyethyl cellulose, and derivatives thereof (including, but not limited to, ethyl hydroxyethyl cellulose and methyl ethyl hydroxyethyl cellulose). Non-limiting examples of commercially available thickeners include CELLOSIZE QP 15,000 (hydroxyethyl cellulose), available from The Dow Chemical Company; ATTAGEL 50 (attapulgite), available from BASF; and BERMOCOLL PRIME (methyl ethyl hydroxyethyl cellulose), BERMOCOLL EHM (hydophobically modified methyl ethyl hydroxyethyl cellulose), and BERMOCOLL E451FQ (ethyl hydroxyethyl cellulose), available from Akzo Nobel.

The coating composition typically comprises a thickening agent in a concentration of from about 0.05% to about 0.5% by weight, for example from about 0.1% to about 0.4% by weight, or from about 0.1% to about 0.3% by weight.

Preservatives, Biocides, and other Excipients

As will be recognized by those skilled in the art, the coating composition may further comprise a preservative, a biocide, or any other additive conventionally incorporated into paint coating compositions. Non-limiting examples of commercially available preservatives include BUSAN 1192 (chlorothalonil), KATHON LX, ROCIMA 586, BIOPAN BP10, DOWACIDE 25L UCARCIDE 25, MERGAL 186, MERGAL 192, and MERGAL 395.

### Color Pigment

The coating composition comprises a one or more pigment components. For example, the coating composition may comprise one or more color pigments, high density pigments, and/or extender pigments.

The coating composition may comprise a color pigment. Suitable color pigments for incorporation into coating compositions are generally known to those skilled in the art. For example, the color pigment may comprise titanium dioxide.

The coating composition typically comprises a color pigment in a concentration of from about 0.5% to about 5% by weight, for example from about 1% to about 3% by weight, or from about 1% to about 2% by weight.

### High Density Pigment

The coating composition may further comprise a high density pigment component. Without being bound to a particular theory, it is believed that the use of a high density pigment component contributes to the sound reducing properties of the coatings described herein.

The high density pigment component may comprise a metal salt. For example, the high density pigment component may comprise a barium salt. Examples of suitable, high-density barium salts include barium sulfate or barium carbonate. In a preferred embodiment, the high density pigment component comprises barium sulfate. Other suitable metal salts include zinc salts, such as zinc sulfide. In some embodiments, the high density pigment component may comprise a mixture of barium and zinc salts (e.g., lithopone).

The high density pigment component can comprise a silicate mineral. The silicate mineral may be naturally occurring (e.g., talc) or synthetic. For example, the high density pigment may comprise a naturally occurring inosilicate mineral, such as a pyroxene mineral. A non-limiting example of a suitable silicate mineral is wallastonite. Non-limiting examples of suitable silicate compounds include magnesium silicate, calcium silicate, and aluminum silicate. For example, the high density pigment may comprise magnesium silicate.

The high density pigment component preferably has a density of at least about 2.5 g/cm³, for example at least about 3 g/cm³, at least about 3.5 g/cm³, at least about 3.75 g/cm³, at least about 4 g/cm³, at least about 4.1 g/cm³, at least about 4.2 g/cm³, at least about 4.3 g/cm³, or at least about 4.4 g/cm³.

Non-limiting examples of commercially available high density pigments include NYTAL 400 (hydrous magnesium silicate), VANSIL W20 (wollastonite), MINFLEX 325 (hydraded magnesium silicate, hydrated magnesium alumino silicate, and quartz), MICROTALC MP 30 (magnesium silicate), TALCRON MP 70-22 (magnesium silicate), and ABT 2500 (talc).

The coating composition typically comprises the high density pigment in a concentration of at least about 10% by weight, for example, at least about 15%, at least about 20%, or even at least about 25% by weight. Accordingly, the coating composition typically comprises the high pigment in a concentration of from about 10% to about 50% by weight, for example from about 15% to about 45% by weight, or from about 20% to about 40% by weight.

### Extender Pigment

The coating composition may further comprise one or more extender pigments. An extender pigment can be used, for example, to lower the cost of producing the coating composition by reducing the amount of the more costly color pigment required needed to achieve the desired color. An extender pigment can also be included to add volume and bulk to the coating composition, thereby reducing the required concentrations of solvent and/or resin components. Non-limiting examples of extender pigments include clays (e.g., calcined kaolin clay), diatomaceous earth, silica and silicates (e.g., aluminum silicate and magnesium silicate), and calcium carbonate. For example, the extender pigment can comprise calcium carbonate.

Non-limiting examples of commercially available extender pigments include POLESTAR 400 (calcined kaolin), GLOMAX LL (calcined kaolin), HYDRITE RSA (hydrous kaolin), SYLOWHITE SM 405 (a precipitated amorphous sodium aluminum silicate), BURGESS OPTIWHITE, NYTAL 300 (a hydrous calcium magnesium silicate mineral mixture), and MINEX 4 (nepheline syenite).

The coating composition typically comprises an extender pigment in a concentration of from about 4% to about 40% by weight, for example from about 5% to about 30% by weight, or from about 10% to about 25% by weight.

### Inhibitor Pigment

The coating composition may further comprise one or more inhibitor pigments that provide resistance to corrosion or other unwanted chemical reactions. Non-limiting examples of inhibitor pigments include borates, molybdates, phosphates and phosphosilicates of zinc, aluminum, calcium, and other metals. Specific, non-limiting examples of inhibitor pigments include zinc oxide and zinc phosphate.

### Binder Component

The coating composition comprises a binder component, which acts to hold the pigment particles together and provides adhesion with the underlying surface to which the coating is applied. In a preferred embodiment, the binder component comprises a resin. For example, the resin may comprise an acrylic polymer. Non-limiting examples of suitable acrylic polymers include alkyl methacrylates (e.g., methyl methacrylate and butyl methacrylate) and polyvinyl esters (e.g., polyvinyl acetate). For example, the resin may comprise polyvinyl acetate. Non-limiting examples of suitable commercially available resins include AVICOR 7448, STANCHEM 5218, STANCHEM 6457, PD0128, AVICOR 7305, AVICOR 390, ENCOR 300, ENCOR 309, ENCOR 320, and ENCOR 357.

The coating composition typically comprises the binder component in a concentration of from about 5% to about 30% by weight, for example from about 10% to about 25% by weight, from about 10% by weight to about 20% by weight, or from about 12% to about 20% by weight. On a volumetric basis, the coating composition typically comprises the binder component in an amount of from about 10% to about 30%, for example from about 15% to about 30%, from about 18% to about 25%, from about 20% to about 30%, or from about 20% to about 25%.

### Coalescing Agent

The coating composition may further comprise a coalescing agent. For example, the coalescing agent may comprise an ester alcohol. An example of a commercially available coalescing agent is TEXANOL ester-alcohol from Eastman Chemical Company.

The coating composition typically comprises a coalescing agent in a concentration of from about 0.2% to about 2% by weight, for example from about 0.5% to about 1.5% by weight, or from about 0.8% to about 1.5% by weight.

### Rheology Modifier

The coating composition may further comprise a rheology modifier. In preferred embodiments, the rheology modifier comprises a polymer selected from the group consisting of polyurethane polymers, polyethylene glycol polymers, and derivatives thereof. For example, the coating composition may comprise a polyether polyurethane polymer, such as a polyether urea polyurethane polymer. Non-limiting examples of commercially available thickening agents include RHEOLATE 125 (an alkali swellable emulsion based on an acrylic backbone), RHEOLATE 216 (a polyether urea polyurethane polymer), RHEOLATE 288 (a polyether polyurethane polymer), and THIXATROL AS8053, available from Elementis Specialties; and OPTIFLOW H7500NF (hydrophobically modified polyethylene glycol) and OPTIFLOW L1400 (hydrophobically modified polyethylene glycol), available from BYK GmbH.

The coating composition typically comprises the rheology modifier in a concentration of from about 0.4% to about 4% by weight, for example from about 0.5% to about 3% by weight, or from about 1% to about 2% by weight.

### Methods of Preparation

Also provided herein are methods of preparing the coating compositions as described herein. Generally, the coating compositions may be prepared using a two step process, comprising a “grind” phase followed by a “letdown” phase.

Grind Phase

In a first step of the preparation process, referred to herein as the grind phase, the pigment components are combined with certain other components to form a grind composition. For example, the grind composition typically comprises an organic solvent, defoamer, dispersant, co-dispersant, thickening agent, preservative and/or biocide, and pigment components as described herein.

Typically, the various components of the grind composition are combined in an aqueous medium. The grind composition typically comprises water in a concentration of from about 50% to about 95% by weight, for example from about 70% to about 90% by weight.

During the grind phase, it is often necessary to disagglomerate the pigment particles in order to stabilize them in an aqueous dispersion. Accordingly, the grind composition is typically mixed continuously at high speed and high shear. In some embodiments, and particularly when the pigments or other components are prone to agglomeration and difficult to disperse, the grind phase may comprise milling the paint composition (for example, using a ball mill, bead mill, or bar mill).

Letdown Phase

In a second step of the preparation process, referred to herein as the letdown phase, the grind composition is combined with the remaining formulation components. Typically, the binder component and coalescing agent are incorporated during the letdown phase, along with the rheology modifier. Optionally, a portion of the defoamer is added during the letdown phase.

The letdown phase may comprise either adding the letdown components into a vessel containing the grind composition, or may comprise adding the grind composition into a vessel containing the letdown components. In either case, it is desirable to agitate the contents of the vessel during the course of the addition process.

### Methods of Application

The coating compositions described herein are suitable for application, for example, to interior or exterior wall, floor, and ceiling surfaces. Advantageously, the coating compositions can be applied using standard painting equipment, including brushes, rollers, paint guns, and other tools and equipment known to those skilled in the art.

Other objects and features will be in part apparent and in part pointed out hereinafter.

### EXAMPLES

The following non-limiting examples are provided to further illustrate the present invention.

### Example 1

A sample coating composition was prepared using the process described below. In a first step of the process, a grind composition was prepared by combining the components set forth in Table 1 below. The table provides the amount of each ingredient, in pounds, added to the mixture. The table also provides the percentage (on a weight basis) of each component relative to the grind mixture as a whole.

TABLE 1

| Component | Quantity (lbs) | Weight % |
|---|---|---|
| Water | 208.4 | 22.38 |
| Propylene glycol | 30.0 | 3.22 |
| Defoamer | 3.75 | 0.40 |
| Anionic dispersant | 7.5 | 0.80 |
| Co-dispersant | 1.5 | 0.16 |
| Preservative | 2.0 | 0.21 |
| Hydroxyethyl Cellulose | 3 | 0.32 |
| Titanium dioxide | 25 | 2.68 |
| Calcium carbonate | 250 | 26.85 |
| Barium sulfate | 400 | 42.96 |
| TOTAL | 931.15 | 100 |

In a second step of the process, a letdown composition was prepared by combining the components set forth in Table 2 below. The table provides the amount of each ingredient, in pounds, added to the mixture. The table also provides the percentage (on a weight basis) of each component relative to the letdown mixture as a whole.

TABLE 2

| Component | Quantity (lbs) | Weight % |
|---|---|---|
| Vinyl acetate resin | 425.0 | 91.10 |
| Coalescing agent | 15.0 | 3.21 |
| Defoamer | 4.5 | 0.96 |
| Polyether urea polyurethane polymer | 22.0 | 4.72 |
| TOTAL | 466.5 | 100 |

The grind composition and the letdown composition were then combined, and mixed until fully incorporated, thereby forming a coating composition.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

1-76: (canceled)

77. An architectural coating composition, the composition comprising:
a high-density pigment component, in a concentration of at least about 10% by weight.
wherein the high-density pigment component comprises a barium salt and has a density of at least about 3 grams/cm³.

78. The coating composition of claim 77, further comprising a rheology modifier in a concentration of from about 0.4% to about 4% by weight.

79. The coating composition of claim 78 wherein the rheology modifier comprises a polyether polyurethane polymer.

80. The coating composition of claim 79 wherein the rheology modifier comprises a polyether polyurethane urea polymer.

81. The composition of claim 77 wherein the high density pigment component comprises barium sulfate.

82. The composition of claim 77 wherein the high density pigment component has a density of at least about 4 g/cm³.

83. The composition of claim 77 wherein the composition comprises the high density pigment component in a concentration of at least about 15% by weight.

84. The composition of claim 77 further comprising an organic solvent component,
wherein the organic solvent component comprises at least one glycol selected from the group consisting of ethylene glycol, propylene glycol, and combinations thereof.

85. The composition of claim 77 further comprising a defoamer selected from the group consisting of silicones, oils, waxes, and combinations thereof.

86. The composition of claim 77 further comprising an anionic dispersant,
wherein the anionic dispersant comprises a polyacrylate polymer or copolymer.

87. The composition of claim 77 further comprising a co-dispersant,
wherein the co-dispersant comprises 2-amino-2-methyl-1-propanol.

88. The composition of claim 77 further comprising an extender pigment selected from the group consisting of clays, diatomaceous earth, silica and silicates, calcium carbonate, and combinations thereof.

89. The composition of claim 88 comprising the extender pigment in a concentration of from about 5% to about 30% by weight.

90. The composition of claim 77 further comprising an inhibitor pigment selected from the group consisting borates, molybdates, phosphates and phosphosilicates of zinc, aluminum, and calcium.

91. The composition of claim 77 further comprising an acrylic polymer selected from the group consisting of alkyl methacrylates, polyvinyl esters, and combinations thereof.

92. The composition of claim 91 wherein the composition comprises the acrylic polymer in a concentration of from about 10% to about 25% by weight.

93. The composition of claim 77 further comprising a coalescing agent,
wherein the coalescing agent comprises an ester alcohol,
and wherein the composition comprises the coalescing agent in a concentration of from about 0.2% to about 2% by weight.

94. The composition of claim 77 wherein the composition has a solids content of at least about 40% by weight.

95. The composition of claim 77 wherein the composition has a total pigment content of from about 20% to about 60% by weight.

96. A method of reducing the transmission of sound into an interior room, the method comprising applying an architectural coating composition as set forth in claim 77 to an interior wall, floor, or ceiling surface.
